(19) United States
(12) Patent Application Publication
(10) Pub. No.: US 2014/0337680 A1
(43) Pub. Date: Nov. 13, 2014

(54) CAN COMMUNICATION APPARATUS AND METHOD THEREOF

(71) Applicant: Electronics and Telecommunications Research Institute, Daejeon-si (KR)

(72) Inventors: Hyun-Yong HWANG, Daejeon-si (KR); Jeong-Hwan LEE, Gyeonggi-do (KR); Tae-Man HAN, Daejeon-si (KR); Oh-Cheon KWON, Daejeon-si (KR)

(73) Assignee: Electronics and Telecommunications Research Institute, Daejeon-si (KR)

(21) Appl. No.: 14/179,013

(22) Filed: Feb. 12, 2014

(30) Foreign Application Priority Data
May 7, 2013 (KR) 10-2013-0051068

(51) Int. Cl. H04L 1/18

(52) U.S. Cl. CPC H04L 1/1809
USPC 714/748

(57) ABSTRACT

A Controller Area Network (CAN) method for transmitting a frame from a transmitting terminal to a receiving terminal, the transmitting terminal being connected to the receiving terminal over a CAN network. The method may include transmitting a plurality of frames, into which a message greater than a pre-set size are segmented, to the receiving terminal, in response to a request from the receiving terminal; checking the frame in response to receiving, from the receiving terminal, a flow control frame that includes sequence number information of a frame where a transmission error occurs; and retransmitting the frame.

### CROSS-REFERENCE TO RELATED APPLICATION(S)

This application claims priority to and the benefit under 35 U.S.C. §119(a) of Korean Patent Application No. 10-2013-0051068, filed on May 7, 2013, in the Korean Intellectual Property Office, the entire disclosure of which is incorporated herein by reference for all purposes.

### BACKGROUND

1. Field

The following description relates to a Controller Area Network (CAN) communication; more specifically, a CAN communication apparatus and method thereof to increase reliability of frame transmission and reception.

2. Description of the Related Art

In the past, cars were just a transport system for carrying people or products. But now, cars are used as an infotainment system, which has the combined functions of information and entertainment in addition to the existing transport system function. For such use of the infotainment system for cars, the CAN is widely being used in industries, especially in an automotive network, due to advantages, such as sophisticated error detection, and the like.

CAN is an efficient serial communication protocol that supports distributed real-time controlling that needs a very high security level. Because a CAN frame transmits data in a fixed length, which is 8 bytes, methods of segmentation and reassembly are used. That is, a single frame or a plurality of consecutive frames may be transmitted depending on a size of a message to be transmitted.

However, in a case where frame damage or loss occurs during the transmission of a frame that is segmented into 8 bytes, a receiving side cannot ignore all the previously successfully transmitted data and restore the original message. Therefore, to restore the message, a transmitting side has to retransmit all the frames composing the message from the beginning, thereby being inefficient.

### SUMMARY

The following description relates to a Controller Area Network (CAN) communication apparatus and method thereof for increasing reliability of data transmission and reception by retransmitting a frame when a transmission error of consecutive frames occurs

In one general aspect, a CAN communication method for transmitting a frame from a transmitting terminal to a receiving terminal, the transmitting terminal being connected to the receiving terminal over a CAN network, the CAN communication method includes, in response to a request from a receiving terminal, transmitting a plurality of frames, into which a message greater than a pre-set size is segmented, to the receiving terminal; in response to receiving, from the receiving terminal, a flow control frame that includes sequence number (SN) information of a frame where a transmission error occurs, checking the frame; and retransmitting the frame to the receiving terminal.

In another general aspect, a CAN communication method for receiving a CAN frame from a transmitting terminal connected to a receiving terminal over a CAN network, the CAN communication method includes, in response to requesting a transmitting terminal for a CAN message, receiving frames segmented into two or more from a transmitting terminal; checking each sequence number (SN) of the frames and whether there are one or more lost SN among the frames; transmitting a flow control frame that includes the one or more lost SN to the transmitting terminal; and re-receiving the frame where the transmission error occurs.

In another general aspect, a CAN communication apparatus includes a message segmenting unit configured to segment a message greater than a pre-set size into a plurality of frames; in response to a request from a receiving terminal connected to a transmitting terminal over a CAN network, a frame transmitting unit configured to transmit the plurality of frames to the receiving terminal; in response to receiving, from the receiving terminal, a flow control frame that includes a sequence number (SN) of a frame where a transmission error occurs, a transmission error checking unit configured to control the frame transmitting unit to retransmit the frame.

In another general aspect, a CAN communication apparatus includes, in response to a request for transmitting a CAN message to a transmitting terminal connected over a CAN network, a frame receiving unit configured to receive frames segmented into two or more from the transmitting terminal; a transmission error checking unit configured to check each sequence number of the frames and whether one or more sequence number are lost, transmit a flow control frame that includes the one or more lost sequence number to the transmitting terminal, and control to re-receive the frame of the sequence number from the transmitting terminal; and a message assembling unit configured to reassemble the frames received from the frame receiving unit, and restore the CAN message.

Other features and aspects may be apparent from the following detailed description, the drawings, and the claims.

### BRIEF DESCRIPTION OF THE DRAWINGS

FIG. 1 is a diagram illustrating an example of a Controller Area Network (CAN) communication apparatus according to an exemplary embodiment of the present invention.

FIGS. 2 and 3 are flowcharts illustrating a general example of a communication method of each CAN module of transmitting and receiving terminals according to an exemplary embodiment of the present invention.

FIG. 4 is a flowchart illustrating an exemplary embodiment of a communication method of each CAN module of transmitting and receiving terminals according to an exemplary embodiment of the present invention.

FIG. 5 is a flowchart illustrating another exemplary embodiment of a communication method of each CAN module of transmitting and receiving terminals according to an exemplary embodiment of the present invention.

FIG. 6A is a detailed diagram illustrating an example of a CAN module of a transmitting terminal according to an exemplary embodiment of the present invention.

FIG. 6B is a detailed diagram illustrating an example of a CAN module of a receiving terminal according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

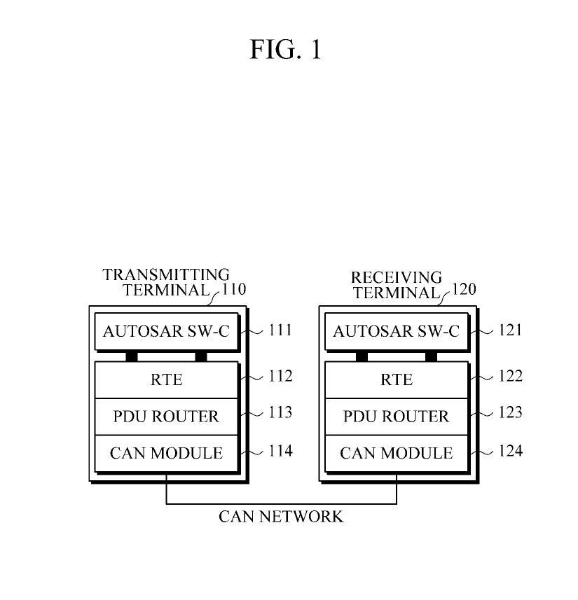

Referring to FIG. 1, a Controller Area Network (CAN) communication apparatus is described hereafter.

Referring to FIG. 1, a CAN communication apparatus includes a transmitting terminal 110 and a receiving terminal 120.

The transmitting terminal 110 and the receiving terminal 120 are Electronic Control Units (ECU), and specifically, includes Automotive Open System Architecture Software Component (AUTOSAR SW-C) 111 and 121, Runtime Environment (RTE) 112 and 122, Protocol Data Unit (PDU) routers 113 and 123, and CAN modules 114 and 124, and may transmit and receive a message to and from each other through the CAN network.

AUTOSAR SW-C 111 and 121, as an application function unit of a car, transmits a message to RTE 112 and 122 and another AUTOSAR SW-C 111 and 121 through a port.

RTE 112 and 122 is a real-time environment where a virtual network is configured in ECU, and supports distributed communications between AUTOSAR SW-C of the ECU that includes the transmitting terminal 110 and the receiving terminal 120. Also, the RTE 112 and 122 transmits the message, received from the AUTOSAR SW-C 112 and 121, to PDU routers 113 and 123.

PDU routers 113 and 123 may interface higher-level RTEs 112 and 122 and lower-level CAN modules 114 and 124, and transmit the message, transmitted from the AUTOSAR SW-C to the RTEs and received from the RTEs, to CAN modules 114 and 124.

CAN modules 114 and 124 execute segmenting the message to be transmitted, which is received from the PDU routers 113 and 123, reassembling a message received through a CAN network, controlling a transmission flow, detecting an error, and cancelling the transmission.

CAN modules 114 and 124 are composed of a CanDriver, a Controller Area Network Interface (CANIF) module, a Controller Area Network Transport Protocol (CANTP) module, a Controller Area Network State Manager (CANSM), a Controller Area Network Manager (CANM), and the like. The CANTP module executes reassembling a message, controlling a transmission flow, detecting an error, and cancelling transmission, etc.

CAN modules 114 and 124 compares a size of the message received from the PDU routers 113 and 123 with a threshold size, determines whether to transmit a single frame or a plurality of consecutive frames, and according to the determination, transmits the single frame or the plurality of the consecutive frames to another terminal through the CAN network. Specifically, if a size of the message transmitted from the PDU router 113 is less than a payload of the single frame, the CAN module 114 of the transmitting terminal loads the message in the single frame and transmits it to the receiving terminal. Otherwise, CAN module 114 of the transmitting terminal segments and loads the message into the plurality of the consecutive frames, and transmits the plurality of the consecutive frames through the CAN network. Then, the CAN module 124 of the receiving terminal reassembles and restores the plurality of the consecutive frames, received from the CAN network, and transmits them to PDU router 123. When a mass amount of data is transmitted between CAN module 114 and CAN module 124, respectively, of the transmitting terminal 110 and the receiving terminal 120 in a CAN network domain, the CAN module 114 transmits the plurality of the CAN frames segmented according to ISO 15765 standards. In ISO 15765 standards, when data size included in a CAN frame is longer than 8 bytes, CAN I-PDU is segmented into CAN N-PDU of an 8-byte unit, and is reassembled.

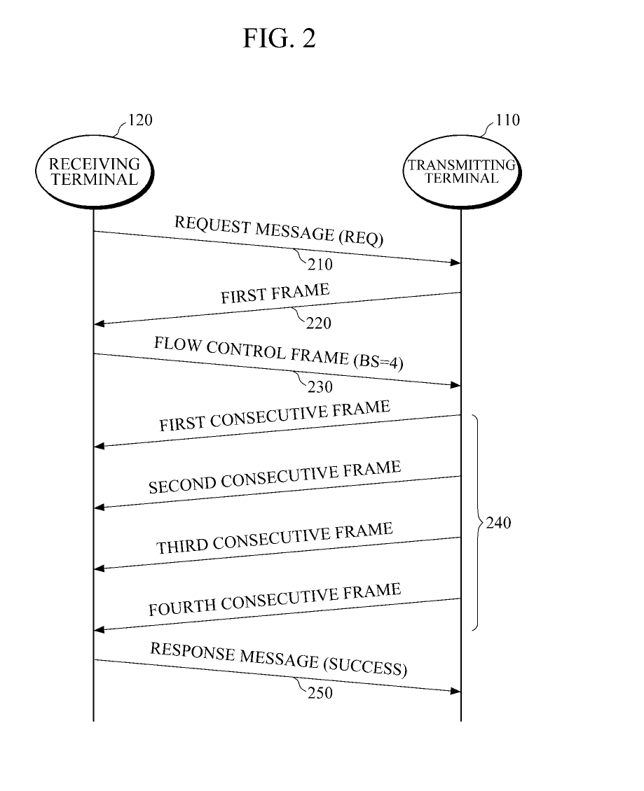

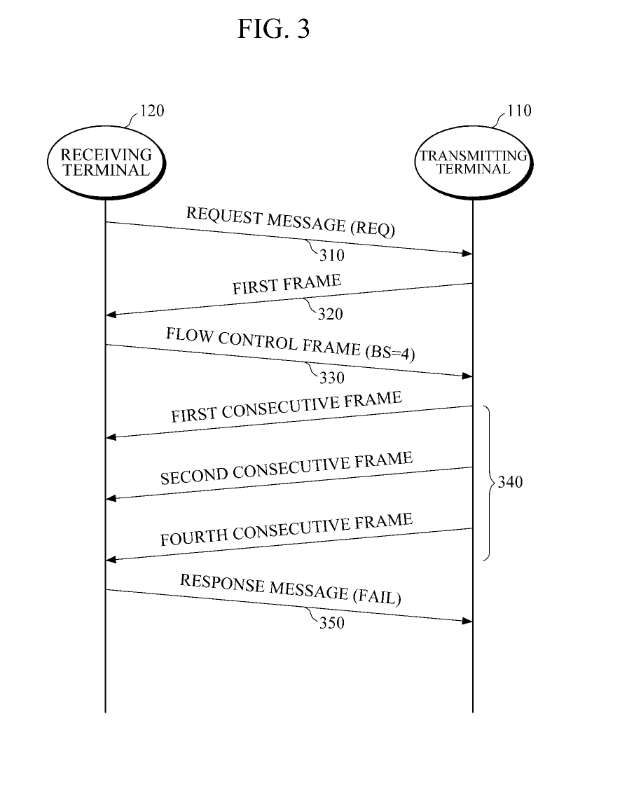

Referring to FIGS. 2 and 3, hereinafter described is a communication method of a CAN module 114 and a CAN module 124 of a general transmitting terminal and a general receiving terminal, through a CAN network, respectively. FIG. 2 is a flowchart in a case in which a transmission or reception error does not occur, and FIG. 3 is a flowchart in a case in which the transmission or reception error occurs.

In FIGS. 2 and 3, a CAN module 114 of a transmitting terminal 110 segments a message received from a PDU router 113 into four pieces, then loads and transmits the segmented message in four consecutive frames. Exemplary embodiments where one block is four-sized are described hereinafter.

Referring to FIG. 2, in response to a request from a receiving terminal 120 in S210, the transmitting terminal 110 transmits a first frame, prior to transmitting four consecutive frames (CF) in S220. At this time, the receiving terminal 120 has already known the number of the consecutive frames to be transmitted.

Then, the receiving terminal 120 transmits, to the transmitting terminal 110, a flow control frame that includes parameters of FS (flow status), BS (block size), and STmin (separation time minimum), in response to the first frame, in 230. Here, the FS parameter is about information for a communication flow control that is pre-set. In addition, the BS parameter is a block size that is pre-set, and a maximum number of the consecutive frames that can be transmitted between the flow control frames. The STmin parameter is a minimum time interval between each consecutive frame that is pre-set. Here, it is assumed that the BS is four.

The transmitting terminal 110 continuously transmits four consecutive frames to the receiving terminal 120, according to the pre-set BS in 240.

In response to receiving the four consecutive frames from the transmitting terminal 110, the receiving terminal 120 transmits a response message to the transmitting terminal 110 in 250. At this time, the receiving terminal 120 checks a sequence number (SN) of the consecutive frames, and determines whether there are consecutive frames not received. Then, if there are no consecutive frames not received, the receiving terminal 120 transmits a response message indicating a reception success.

Not illustrated in FIG. 2, when the CAN module 124 of the receiving terminal 120 successfully receives all the four consecutive frames, it assembles and restores all the four consecutive frames, and transmits them to the AUTOSAR SW-C 121 through the PDU router 123 and RTE 122. At this time, the receiving terminal 120 may check the SN of the consecutive frames, and determine whether the consecutive frames are successfully received.

However, in a case where the receiving terminal 120 does not receive any one of the 4 consecutive frames (a first to fourth consecutive frames), the receiving terminal 120 may transmit a response message indicating the reception failure as illustrated in FIG. 3.

Referring to FIG. 3, the transmitting terminal 110 continuously transmits the four consecutive frames depending on a pre-set block size in 340. However, because the CAN network has a problem, the third consecutive frame, whose SN is 3, may be damaged or lost. In this case, the receiving terminal 120 receives only three normal consecutive frames in 340.

Then, the receiving terminal 120 checks the SN of the consecutive frames, and also checks whether there are any consecutive frames that cannot be received. As a result, since there are consecutive frames that cannot be received, the receiving terminal 120 transmits a response message indicating a reception failure in 350.

In this case of the reception failure, all the three consecutive frames that have been normally transmitted previously are discarded, so that the message cannot be restored, and the frames should be transmitted again from the beginning, which causes lower transmission efficiency.

To solve the problem, the CAN communication apparatus and method thereof provides two embodiments to effectively transmit a message depending on a message transmission error.

In one embodiment, when the receiving terminal 120 notifies SN of the lost frame to the transmitting terminal 110 through the flow control frame, the transmitting terminal 110 transmits the frames again starting from the lost frame.

In the other embodiment, when the receiving terminal 120 notifies SN of the lost frame to the transmitting terminal 110 through the flow control frame, the transmitting terminal 110 transmits only the lost frame.

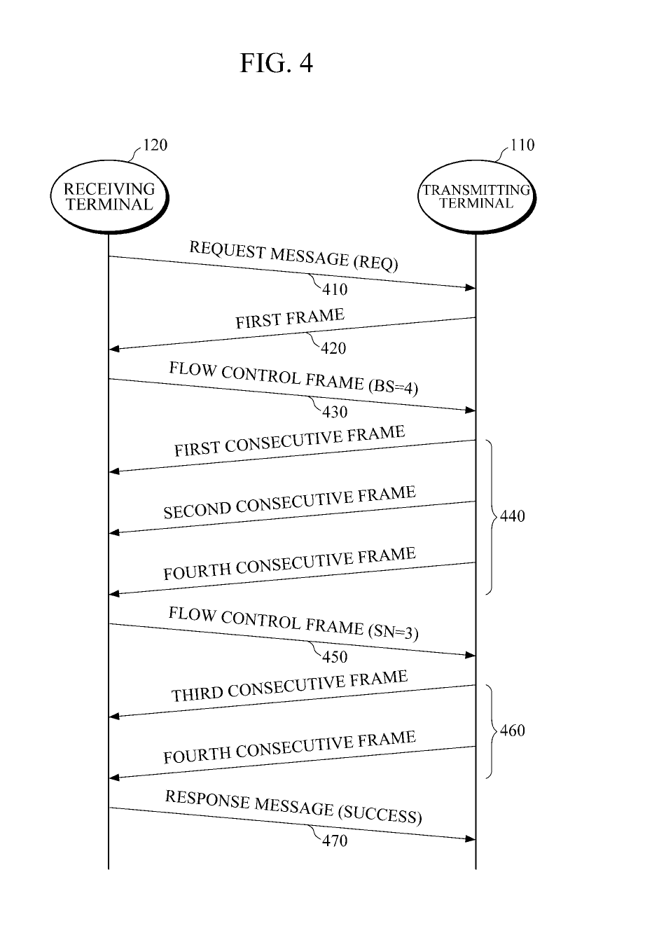

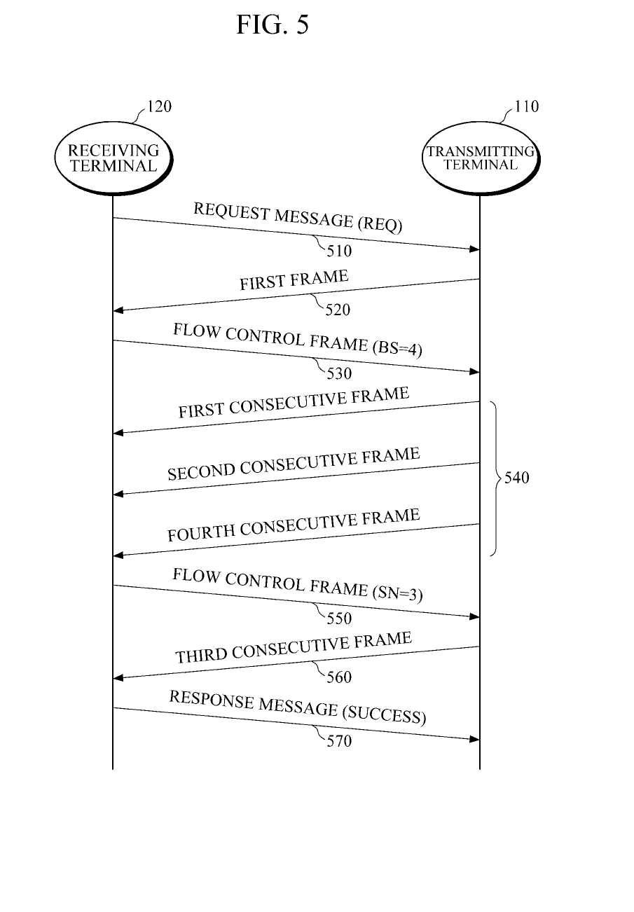

Each embodiment is hereafter described with reference to FIGS. 4 and 5.

FIG. 4 is a flowchart illustrating an exemplary embodiment of a communication method of each CAN module of transmitting and receiving terminals according to an exemplary embodiment of the present invention.

Referring to FIG. 4, if the receiving terminal 120 transmits a request message (REQ) to the transmitting terminal 110 in 410, the transmitting terminal 110 segments a message that is greater than a pre-set size, generates a plurality of consecutive frames, puts an SN for each consecutive frame, and prepares for transmitting the plurality of consecutive frames.

Prior to transmitting four consecutive frames (CF), the transmitting terminal 110 transmits a first frame to the receiving terminal 120 in 420. Also, in response to the first frame, the receiving terminal 120 transmits, to the transmitting terminal 110, a flow control frame that includes parameters of FS, BS, and STmin in S430.

Then, the transmitting terminal 110 consecutively transmits the four consecutive frames according to a pre-set block size in 440. While receiving the consecutive frames, the receiving terminal 120 checks the SN of the consecutive frames, and whether there are any consecutive frames that cannot be received.

If the receiving terminal 120 determines failure about a reception of a third consecutive frame (CF #3) among first to fourth consecutive frames (CF #1˜CF #4), the receiving terminal 120 transmits another flow control frame that includes information of the CF #3 in 450. At this time, the transmitted flow control frame may include an SN parameter, as well as FT (Frame Type), FS, BS, and STmin parameters. In other words, the SN parameter includes the SN (SN=3) of lost consecutive frame. Thus, the transmitting terminal 110 checks the SN of the consecutive frame that the receiving terminal 120 fails to receive, through the SN of the flow control frame.

Then, if receiving the flow control frame in 450, the transmitting terminal 110 checks, through the flow control frame, that the consecutive frame, which the receiving terminal 120 fails to receive, is the third consecutive frame (CF #3). Then, the transmitting terminal 110 retransmits frames from the CF #3 to the CF #4 that is a last frame of a block where the CF #3 is included, in 460.

If the receiving terminal 120 succeeds in receiving the retransmitted CF #3 to CF #4, the receiving terminal 120 transmits a response message indicating the reception success to the transmitting terminal 110 in 470. Then, the receiving terminal 120 can restore the message after reassembling the CF #1 to CF #4.

FIG. 5 is a flowchart illustrating another exemplary embodiment of a communication method of each CAN module of transmitting and receiving terminals according to an exemplary embodiment of the present invention.

Referring to FIG. 5, if a receiving terminal 120 transmits a request message (REQ) to a transmitting terminal 110 in 510, a transmitting terminal 110 transmits a first frame to the receiving terminal 120 in 520, prior to transmitting four consecutive frames (CF). In response to the first frame, the receiving terminal 120 transmits a flow control frame that includes parameters of FS, BS, and STmin in 530.

Then, the transmitting terminal 110 consecutively transmits four consecutive frames according to a pre-set block size in 540. While receiving the consecutive frames, the receiving terminal 120 checks the SN of the consecutive frames, and whether there are any consecutive frames not received.

If the receiving terminal 120 determines failure about a reception of a third consecutive frame (CF #3) among first to fourth consecutive frames (CF #1˜CF #4), the receiving terminal 120 transmits another flow control frame that includes information of the CF #3 in 550. Here, the flow control frame includes an SN (SN=3) of the lost consecutive frames.

Then, if receiving the flow control frame in 550, the transmitting terminal 110 checks, through the flow control frame, that the consecutive frame failing to be received is the third consecutive frame (CF #3). Then, the transmitting terminal 110 retransmits only the CF #3 in 560.

If the receiving terminal 120 succeeds in receiving the retransmitted CF #3, the receiving terminal 120 transmits a response message indicating the reception success to the transmitting terminal 110 in 570. Then, the receiving terminal 120 can restore the message after reassembling the CF #1 to CF #4.

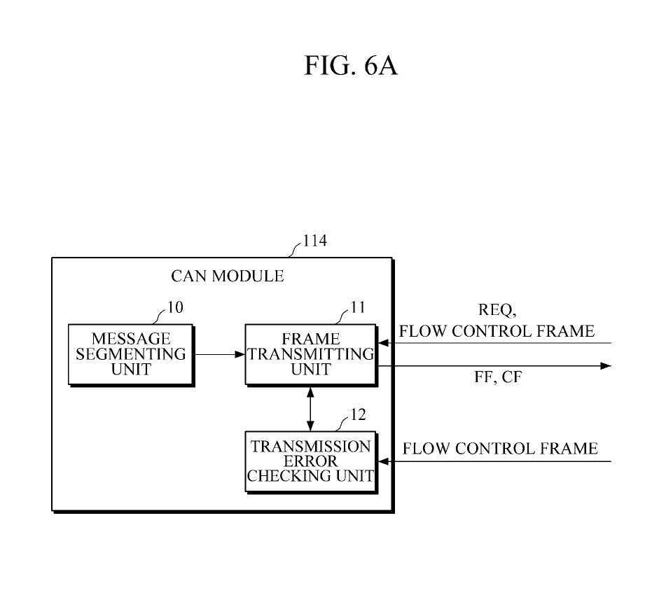

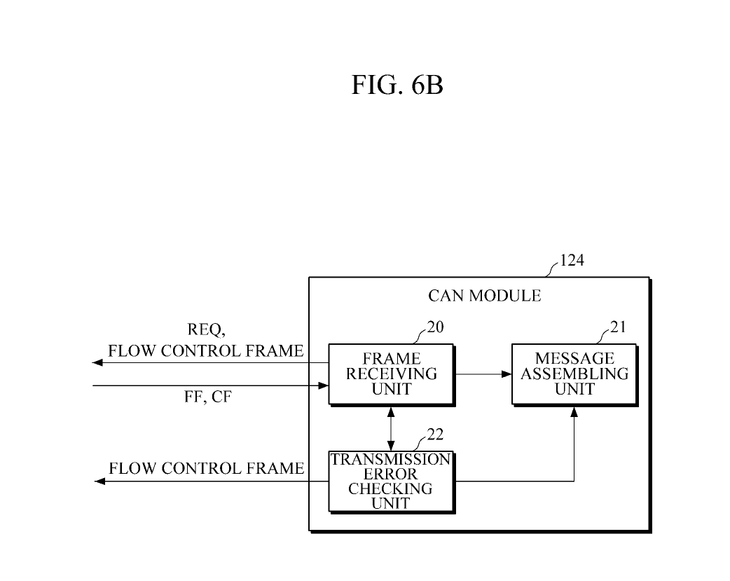

FIG. 6A is a detailed diagram illustrating an example of a CAN module of a transmitting terminal.

Referring to FIG. 6A, a CAN module 114 of a transmitting terminal 110 in FIG. 1 includes a message segmenting unit 10, a frame transmitting unit 11, and a transmission error checking unit 12.

The message segmenting unit 10 segments a message, which is to be transmitted, into two or more frames. The segmented frames may include a first frame (FF) and one or more consecutive frames (CF).

In response to receiving a request message (REQ) from a receiving terminal 110, the frame transmitting unit 11 consecutively transmits the first frame, which is segmented by a message segmenting unit 10, and the one or more CFs. At this time, in response to transmitting the first frame, the transmitting terminal 110 receives a flow control frame from a receiving terminal 120 in FIG. 1, and then consecutively transmits the one or more CFs in reference to parameters of FS, BS, and STmin, which are included in the flow control frame.

In response to receiving another flow control frame from the receiving terminal 120, the transmission error checking unit 12 checks an SN of the consecutive frame, which the transmitting terminal 110 fails to transmit to the receiving terminal 120, through the SN of the flow control frame.

In addition, the transmission error checking unit 12 controls the frame transmitting unit 11 to retransmit a frame that corrects the transmission error. In an embodiment, the transmission error checking unit 12 controls the frame transmitting unit 11 to transmit all the frames starting from the CF, which the transmitting terminal 110 fails to transmit, to a last frame of a block where the CF is included. In another embodiment, the transmission error checking unit 12 controls to retransmit only the CFs that the transmitting terminal 110 fails to transmit.

FIG. 6B is a detailed diagram illustrating an example of a CAN module of a receiving terminal.

Referring to FIG. 6B, a CAN module 124 of a receiving terminal 120 in FIG. 1 may include a frame receiving unit 20, a message assembling unit 21, and a transmission error checking unit 22.

The frame receiving unit 20 requests (REQ) a transmitting terminal 110 in FIG. 1 for transmitting a predetermined message. Then, when receiving a first frame (FF) of the predetermined message from the transmitting terminal 110, the frame receiving unit 20 transmits a flow control frame that includes FS, BS, and STmin parameters, in response to the first frame. Then, the frame receiving unit 20 consecutively receives CFs according to a pre-set block size. In an embodiment of the CAN communication apparatus and method thereof, the frame receiving unit 20 receives the retransmitted frames.

The message reassembling unit 21 assembles two or more frames received from the frame receiving unit 20, and restores the message.

The transmission error checking unit 22 checks an SN of the consecutive frame, and whether there are any CFs not received. Then, in response to determining that there are lost CFs among the CFs, the transmission error checking unit 22 transmits another flow control frame, which includes information of the lost CFs, to the transmitting terminal 110. Here, the transmitted flow control frame includes further includes an SN parameter, as well as FT, FS, BS, and STmin parameters. In other words, the flow control frame includes the SN of the lost CFs.

The transmission error checking unit 22 controls the frame receiving unit 20 to re-receive a frame that corrects the transmission error. In an embodiment, the transmission error checking unit 22 controls to re-receive all the frames starting from the CF, which the transmitting terminal 110 fails to transmit, to a last frame of a block where the CF is included. In another embodiment, the transmission error checking unit 22 controls to re-receive only the CFs that the transmitting terminal 110 fails to transmit.

In an embodiment, in a case where damage or loss of data occurs in process of transmitting the data that is segmented into CAN frames, the CAN communication apparatus and method thereof may check whether there are any CFs that cannot be received, and also requests retransmission of the not-received CFs, which can increase a message restoring rate.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A Controller Area Network (CAN) communication method for transmitting a frame from a transmitting terminal to a receiving terminal, the transmitting terminal being connected to the receiving terminal over a CAN network, the CAN communication method comprising:
in response to a request from a receiving terminal, transmitting a plurality of frames, into which a message greater than a pre-set size is segmented, to the receiving terminal;
in response to receiving, from the receiving terminal, a flow control frame that includes sequence number (SN) information of a frame where a transmission error occurs, checking the frame; and
retransmitting the frame to the receiving terminal.

2. The CAN communication method of claim 1, wherein the retransmitting of the frame comprises retransmitting, to the receiving terminal, all the frames from the frame, where the transmission error occurs, to a last frame.

3. The CAN communication method of claim 1, wherein the pre-set size is 8 bytes according to International Standardization Organization (ISO) 15765.

4. The CAN communication method of claim 1, wherein the transmitting of the plurality of frames to the receiving terminal further comprises:
transmitting a first frame;
in response to the first frame transmission, receiving a flow control frame that includes a block size parameter which is a maximum of consecutive frames; and
consecutively transmitting the consecutive frames of a number based on the block size.

5. A CAN communication method for receiving a CAN frame from a transmitting terminal connected to a receiving terminal over a CAN network, the CAN communication method comprising:
in response to requesting a transmitting terminal for a CAN message, receiving frames segmented into two or more from a transmitting terminal;
checking each sequence number (SN) of the frames and whether there are one or more lost SN among the frames;
transmitting a flow control frame that includes the one or more lost SN to the transmitting terminal; and
re-receiving the frame where the transmission error occurs.

6. The CAN communication method of claim 5, wherein the re-receiving of the frame where the transmission error occurs comprises re-receiving all the frames from the frame, where the transmission error occurs, to a last frame.

7. The CAN communication method of claim 5, wherein the receiving of the frames further comprises:
receiving a first frame;
in response to the first frame reception, transmitting a flow control frame that includes a block size parameter which is a maximum of consecutive frames; and
consecutively receiving the consecutive frames of a number based on the block size.

8. The CAN communication method of claim 5, further comprising:
restoring the CAN message by assembling the received frames.

9. The CAN communication method of claim 5, further comprising:
in response to succeeding in receiving the frames from the transmitting terminal, transmitting a response message, which indicates a reception success, to the transmitting terminal.

10. A CAN communication apparatus, comprising:
a message segmenting unit configured to segment a message greater than a pre-set size into a plurality of frames;
in response to a request from a receiving terminal connected to a transmitting terminal over a CAN network, a frame transmitting unit configured to transmit the plurality of frames to the receiving terminal;
in response to receiving, from the receiving terminal, a flow control frame that includes a sequence number (SN) of a frame where a transmission error occurs, a transmission error checking unit configured to control the frame transmitting unit to retransmit the frame.

11. The CAN communication apparatus of claim 10, wherein the transmission error checking unit comprises retransmitting all the frames starting from the frame, where the transmission error occurs, to a last frame

12. The CAN communication apparatus of claim 10, wherein the frame transmitting unit transmits a first frame, and in response to the first frame transmission, receives a flow control frame that includes a block size parameter, which is a maximum of consecutive frames, and consecutively transmits the consecutive frames of a number based on the block size.

13. A CAN communication apparatus, comprising:
in response to a request for transmitting a CAN message to a transmitting terminal connected over a CAN network, a frame receiving unit configured to receive frames segmented into two or more from the transmitting terminal;
a transmission error checking unit configured to check each sequence number of the frames and whether one or more sequence number are lost, transmit a flow control frame that includes the one or more lost sequence number to the transmitting terminal, and control to re-receive the frame of the sequence number from the transmitting terminal; and
a message assembling unit configured to reassemble the frames received from the frame receiving unit, and restore the CAN message.

14. The CAN communication apparatus of claim 13, wherein the transmission error checking unit controls to re-receive all the frames starting from the frame, where the transmission error occurs, to a last frame.

15. The CAN communication apparatus of claim 13, wherein the frame receiving unit receives a first frame, and in response to the first frame reception, transmits a flow control frame that includes a block size parameter which is a maximum of consecutive frames, and consecutively receives consecutive frames of a number based on the block size.
